(19) United States
(12) Patent Application Publication
(10) Pub. No.: US 2007/0164243 A1
(43) Pub. Date: Jul. 19, 2007

(54) THREE-WAY DIRECT PILOT VALVE

(75) Inventor: Gregory Volz, Lincoln Park, NJ (US)

Correspondence Address: LOCKE LIDDELL & SAPP LLP;ATTN: IP DOCKETING, 600 TRAVIS STREET, 3400 CHASE TOWER, HOUSTON, TX, 77002, US

(73) Assignee: ASCO CONTROLS, L.P., Florham Park, NJ (US)

(21) Appl. No.: 11/622,264

(22) Filed: Jan. 11, 2007

Related U.S. Application Data
(60) Provisional application No. 60/758,848, filed on Jan. 13, 2006.

(51) Int. Cl. F16K 31/12

(52) U.S. Cl. 251/30.03

(57) ABSTRACT

The present disclosure provides a method, apparatus, and system of an inline direct acting solenoid pilot valve. The valve has a solenoid assembly with a longitudinally moveable core assembly that shifts alternatively between sealing engagement on a lower first end of the core assembly with a pilot port formed in a poppet and sealing engagement on an opposite upper end with a stationary pilot exhaust port in the solenoid assembly. The core assembly can move in the same or opposite direction than the poppet and thus is independently moveable from the poppet to effect the various modes of operation. Because the movement is independent, the core assembly can advantageously operate within the solenoid with a shorter stroke to produce a higher overall force per length relative to a conventional core assembly stroke that is longer than the poppet stroke. The overall design allows a more compact and simplified design.

### CROSS REFERENCE TO RELATED APPLICATIONS

This application claims the benefit of U.S. Provisional Application No. 60/758,848, filed Jan. 13, 2006, and is incorporated herein by reference.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO APPENDIX

Not applicable.

### BACKGROUND

1. Field of the Invention

The invention relates to control valves. More specifically, the invention relates to pilot valves for the control of a device.

2. Description of Related Art

Control valves are widely used in industry generally to control the flow of fluid through interconnected flow paths. A pilot valve is a particular category of control valve that can operate on relatively small fluidic flow rates or small amounts of electrical power from a control system. Often a pilot valve is used in conjunction with a fluidic cylinder to actuate other devices or with a larger main valve that is sufficiently sized to accommodate production flow capacities. Without the pilot valve, the cylinder may be difficult to control or the main valve might require a larger than available power source to operate and function as intended. The pilot valve is often activated by an electrical solenoid built into the pilot valve that can move an armature from an magnetic field created by applying electricity to a coil surrounding the armature. The movement of the armature is the method used by pilot valves to actuate other portions of the pilot valve and ultimately the cylinder or main valve if so linked.

Thus, pilot valves fulfill an important function and reliability is critical in many applications. Since the electrical solenoid can only move the armature in an up-and-down motion, often complex linkages and flow paths are needed to allow the pilot valve to function in a desired manner to provide the various flow paths. Further, if power is lost to the solenoid or from an inlet pressure, the pilot valve may fail in an uncontrolled position, in turn causing the cylinder or the main valve coupled to the pilot valve to also fail. More linkages, more seals, and more cumulative effects of combined manufacturing tolerances can create difficulty in providing a reliable pilot valve. Yet, the complexity is often necessary to accomplish the needed flow path interconnections.

A category of simpler valves is generally known as direct acting pilot valves that align the solenoid with the pilot port. Such valves have gained industry acceptance, where the movable solenoid seals against a stationary pilot port to turn the valve flow path off and on, similar to the design and operation of a globe valve. Such pilot valves may be relatively simple in design but are not able to accomplish some desired operations, due to their simplicity, such as being generally limited in their flow areas at a given pressure due to the power required to actuate a sufficiently large solenoid.

Still other pilot valves, such as a pilot diaphragm valve, have a pilot linked to the movement of the flow control element such as a diaphragm. The movement of the diaphragm is linked to the movement of the pilot. A piloted piston in a typical type of valve is similarly linked to the movement of the pilot. Further, in a typical solenoid operated piloted valve, the armature movement is in the same direction as the piston or diaphragm movement, so that the movements are dependent on each other. Due to necessary clearances for flows in the valve, the armature stroke is required to be longer than the piston or diaphragm stroke. This longer stroke is necessary because the armature must seal off the piston or diaphragms in the de-energized state and also maintain a clearance at the same interface, in the energized position. The force generated by a solenoid decreases sharply as the armature extends in its stroke, and causes design complications to provide adequate force throughout the armature stroke for the valve to operate properly.

The field of valves is crowded with modifications that may seem minor in hindsight, but can have significant impact on operation and manufacture and even maintenance. In spite of the various improvements, there still remains a need to simplify the design and still be able to accomplish the desired results of a pilot valve.

### BRIEF SUMMARY

The present disclosure provides a method, apparatus, and system of an inline direct acting solenoid pilot valve. The valve has a solenoid assembly with a longitudinally moveable core assembly that shifts alternatively between sealing engagement on a lower first end of the core assembly with a pilot port formed in a poppet and sealing engagement on an opposite upper end with a stationary pilot exhaust port in the solenoid assembly. The core assembly can move in the same or opposite direction than the poppet and thus is independently moveable from the poppet to effect the various modes of operation. Because the movement is independent, the core assembly can advantageously operate within the solenoid with a shorter stroke to produce a higher overall force per length relative to a conventional core assembly stroke that is longer than the poppet stroke. The overall design allows a more compact and simplified and therefore believed to be more reliable design for a pilot valve that still achieves the purposes intended for a three way pilot valve. The pilot port and the pilot exhaust port are disposed opposite one another relative to the core assembly. The core assembly has resilient sealing discs mounted on each end that act to seal either the poppet pilot port or the pilot exhaust port, depending on whether the solenoid is de-energized or energized, respectively. The solenoid assembly and its core assembly are aligned axially with the poppet and operate as part of a pressurized region in the valve. The valve system features a pilot core assembly that acts directly on the movable poppet, in contrast to a typical valve that uses a pilot located remotely on the assembly and seals on a stationary seat. In a de-energized position, the poppet is in its uppermost position and allows flow from the device port to the outlet port and blocks off the inlet port. In an energized state, the poppet is in its lowermost position and allows fluid to flow from the inlet port to the device port while the outlet port is shut off The poppet is controlled through a pressure differential across a poppet piston in conjunction with actuation of the core assembly.

The disclosure provides a pilot valve, comprising: a body having an inlet port, a device port, and an outlet port formed in the body to establish one or more flow paths, the body further having a main flow opening having a first seat distal from the inlet port; a solenoid base subassembly coupled to the body comprising: a stopper having: a pilot exhaust port formed longitudinally through the stopper; and a bonnet having: a first opening formed longitudinally in the bonnet and aligned with the pilot exhaust port adjacent the pilot exhaust port seat; and a second opening aligned with the first opening, the second opening being formed in the bonnet and distal from the pilot exhaust port of the stopper; and a core tube adapted to couple the stopper and the bonnet with a gap formed between the stopper and bonnet; a core assembly slidably coupled to the solenoid base subassembly in the first and second openings, comprising: a core having a core opening formed longitudinally through the core and axially aligned with the body main flow opening; a first seal disc slidably disposed in the core opening toward the pilot exhaust port for sealing engagement with the exhaust port; a second seal disc slidably disposed in the core opening toward the body main flow opening and distal from the pilot exhaust port; and a spring disposed in the core opening between the first seal disc and the second seal disc; a solenoid assembly disposed around at least a portion of the solenoid base subassembly, the solenoid assembly having a toroidal coil adapted to be energized to create a magnetic field longitudinally through the solenoid base subassembly; a poppet slidably disposed in the second opening of the bonnet and the main flow opening of the body, the poppet having: a poppet piston slidably disposed in the second opening of the bonnet, the poppet piston having a port in communication between the inlet port and the core assembly, the port being aligned with the second seal disc of the core assembly for sealing engagement with the second seal disc; and a seat seal coupled to the poppet distal from the second opening and adapted to sealably engage the first seat distal on the main flow opening distal from the poppet piston relative to the main flow opening; and a second seat coupled to the body distal from the poppet piston and adapted to be engaged by the seat seal distal from the first seat, the poppet having a stroke between the first seat and the second seat.

A pilot valve, comprising: a body having an inlet port, a device port, and an outlet port formed in the body to establish one or more flow paths; a solenoid base subassembly; a solenoid assembly disposed around at least a portion of the solenoid base subassembly, the solenoid assembly having a toroidal coil adapted to be energized to create a magnetic field longitudinally through the solenoid base subassembly; a core assembly slidably coupled to the solenoid base subassembly, the core assembly having a core stroke; a poppet slidably disposed in the valve body, the poppet having a poppet stroke; wherein the core assembly can move independently in the same or different direction as the poppet to operate the valve between an energized state and a de-energized state.

The disclosure also provides a pilot valve, comprising: a body having an inlet port, a device port, and an outlet port formed in the body to establish one or more flow paths, the body further having a main flow opening having a first seat distal from the inlet port; a solenoid base subassembly coupled to the body comprising: a stopper having a pilot exhaust port formed longitudinally through the stopper; a bonnet coupled to the stopper having a first opening formed longitudinally in the bonnet and aligned with the pilot exhaust port; and a core assembly slidably coupled to the solenoid base subassembly in at least the first opening, the core assembly having a first end and a second end and a sealing surface disposed on each end; a solenoid assembly disposed around at least a portion of the solenoid base subassembly, the solenoid assembly having a coil adapted to be energized to create a magnetic field longitudinally through the solenoid base subassembly; a poppet slidably disposed in the second opening of the bonnet and the main flow opening of the body, the poppet having: a poppet piston slidably disposed at least partially in the bonnet, the poppet piston having a pilot port in communication between the inlet port and the core assembly, the port being aligned with a least one of the sealing surfaces of the core assembly for sealing engagement; and a seat seal coupled to the poppet distal from the bonnet relative to the poppet piston and adapted to sealably engage the first seat of the main flow opening distal from the poppet piston; and a second seat coupled to the body distal from the poppet piston and adapted to be engaged by the seat seal distal from the first seat, the poppet having a stroke between the first seat and the second seat.

The disclosure further provides a method of operating a pilot valve having an inlet port, a device port, and a outlet port defining at least two flow paths, comprising: pressurizing an inlet port of a de-energized valve; energizing a coil of a solenoid assembly coupled to the valve and surrounding a movable core assembly of the valve to pull the core assembly toward a stationary stopper having a pilot exhaust port distal from the inlet port; sealing the pilot exhaust port with a seal coupled to the core assembly; flowing pressurized fluid from the inlet port through a pilot port in a piston of a slidable poppet to create a first force on a portion of the poppet piston distal from the inlet port; and forcing with the force the poppet piston toward a main flow opening in the valve and axially aligned with the poppet, to move a biased seat seal axially coupled with the poppet from a first main seat to a second main seat to open a flow path between the inlet port and the device port.

### BRIEF DESCRIPTION OF THE DRAWINGS

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art as required by 35 U.S.C. § 112.

FIG. 1 is a perspective schematic view of an exemplary pilot valve according to the teachings in this disclosure.

FIG. 2 is a schematic assembly view of the exemplary pilot valve of FIG. 1.

FIG. 3 is a cross-sectional schematic diagram of the exemplary pilot valve in a de-energized state.

FIG. 4 is a cross-sectional schematic view of the solenoid base subassembly.

FIG. 5 is a prospective schematic view of the core assembly.

FIG. 6 is a top schematic view of the core assembly of FIG. 5.

FIG. 7 is a cross-sectional schematic view through FIG. 6 of the core assembly.

FIG. 8 is a cross-sectional schematic view of the poppet.

FIG. 9 is a cross-sectional schematic view of the wall seal.

FIG. 10 is a cross-sectional schematic view of the seat seal.

FIG. 11 is a cross-sectional schematic view of a seal support.

FIG. 12 is a top schematic view of the guide ring.

FIG. 13 is a top perspective schematic view of the guide ring.

FIG. 14 is a cross-sectional schematic diagram of the exemplary pilot valve in an energized state.

FIG. 15 is a cross-sectional schematic diagram of the exemplary pilot valve in a de-energizing state shown with the core assembly still adjacent the poppet seat.

### DETAILED DESCRIPTION

One or more illustrative embodiments incorporating the invention disclosed herein are presented below. Not all features of an actual implementation are described or shown in this application for the sake of clarity. It is understood that the development of an actual embodiment incorporating the present invention, numerous implementation-specific decisions must be made to achieve the developer's goals, such as compliance with system-related, business-related and other constraints, which vary by implementation and from time to time. While a developer's efforts might be complex and time-consuming, such efforts would be, nevertheless, a routine undertaking for those of ordinary skill in the art having benefit of this disclosure.

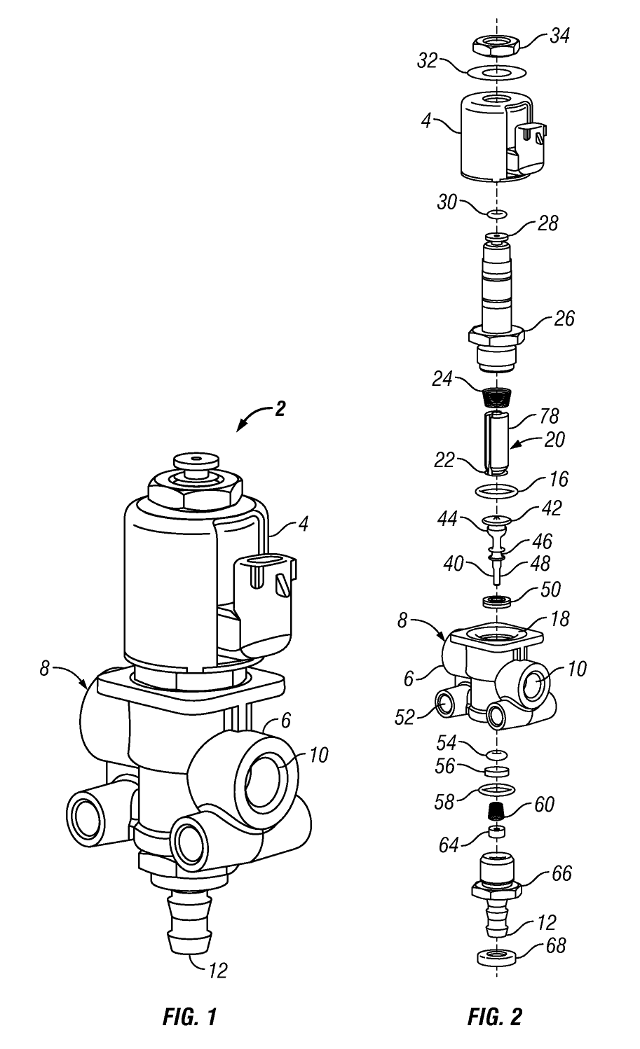

FIG. 1 is a perspective schematic view of an exemplary pilot valve according to the teachings in this disclosure. The pilot valve 2 includes generally a solenoid assembly 4 coupled to a body 6. The body 6 in at least one embodiment includes an inlet port 8, a device port 10, and an outlet port 12. The operation of the pilot valve 2 provides at least two selectively controllable flow paths, where one flow path is between the inlet port 8 and the device port 10, and the second flow path is between the device port 10 and the outlet port 12. The inlet port generally has a positive fluid pressure from a pneumatic or hydraulic source (not shown). The device port is generally fluidically coupled to a device not shown, such as a cylinder or main valve, for operation of the device with the fluidic pressure and flow through the pilot valve 2. The outlet port 12 is the port through which the device port 10 can exhaust its fluid to a reservoir (not shown), such as a container or the atmosphere, to release the device into a default position. The device default position can be a spring return position of a cylinder or main valve, or other position, when no pressurized fluid is provided to the device. To control the flow paths, the pilot valve 2 generally uses the selectively actuated solenoid with a movable armature, herein termed a “core assembly.” The solenoid assembly 4 is connectable to an electrical source to selectively power the solenoid assembly.

FIG. 2 is a schematic assembly view of the exemplary pilot valve of FIG. 1. An O-ring 16 is generally sized to fit a recess 18 formed in the pilot valve body 6. The O-ring seals the openings in the valve body 6 with a solenoid base subassembly 26 described below. A core assembly 20 is sized to fit within the solenoid base subassembly 26. The core assembly generally includes a core 78, a spring seat 22, such as a recess, to retain the position of a core assembly return spring 24, inserted thereover. The core assembly and spring fit inside an opening through the center of the solenoid base subassembly 26. A flange 28 is formed at an upper end of the solenoid base subassembly 26. An O-ring 30 is sized to fit over the flange 28 to selectively seal an opening formed below the flange 28. A washer 32 and a nut 34 are sized to receive an upper portion of the solenoid base subassembly 26 inserted through an opening in the solenoid assembly 4, and secure the solenoid base subassembly into the solenoid assembly 4.

Below the solenoid subbase subassembly 26, a poppet 40 and related assemblies are coupled with the body 6. The poppet 40 generally includes an upper portion having a poppet piston 42 with a first cross-sectional square area. A wall seal recess 44 is formed below the poppet piston 42 to receive a wall seal 50. The wall seal 50 can be a U-cup type of seal having an open bottom, known to those with ordinary skill in the art. The poppet 40 can further include a seat seal recess 46 formed below the wall seal recess 44. The seat seal recess 46 can receive a seat seal 54. The seat seal 54 can be, for example, an O-ring. Further, the poppet 40 can include a poppet guide 48 extending below the seat seal recess 46. The cross-sectional area of the seat seal recess 46 coupled with the O-ring 54 forms a second cross-sectional area that is generally less than the first cross-sectional area of the poppet piston 42. A seal support 56 is sized to be pressed over the outer diameter of the seat seal 54 to assist in retaining the seat seal 54 in a fixed outer diameter. An O-ring 58 is sized to seal an outlet fitting 66 to the body 6. A poppet return spring 60 is sized to be inserted over the poppet guide 48 and engage the bottom portion of the seat seal recess 46 to bias the poppet upwardly. A guide ring 64 is formed and sized to fit within the body 6 and surround the outer diameter of the poppet guide 48. The poppet guide 48, coupled with the guide ring 64, assists in maintaining an alignment of the poppet 40 as it moves up and down in its stroke in the valve body 6. The outlet fitting 66 can be formed to be coupled with tubing, and other conduit to direct exhaust fluids, such as gases, from the valve. A cap 68 is sized to be inserted over at least a portion of the outlet fitting 66 to assist in coupling the tubing to the fitting.

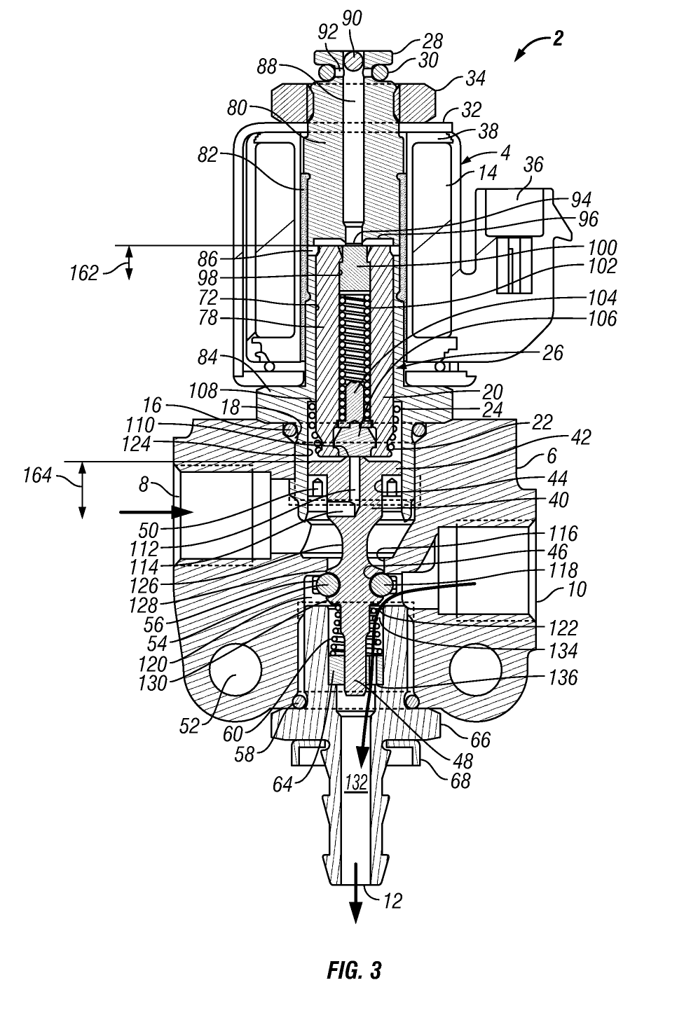

FIG. 3 is a cross-sectional schematic diagram of the exemplary pilot valve in a de-energized state. The element numbers described in FIGS. 1 and 2 are repeated herein with the additional description of further elements. In a de-energized state, the poppet is in an uppermost position, the core assembly is resting on the poppet seat, the inlet port is shut off, and the device port and outlet port are in communication, as described below.

One aspect of this design is that the core assembly and poppet can move independently of one another in that the core assembly and poppet move in opposite directions during certain modes of the valve operation and the same direction during other modes of the valve operation. During the de-energizing mode of operation for this valve, the core assembly drops down to a position lower than that of the resting position in order to seal off on the poppet seat and the poppet seat seal moves to its uppermost position against an upper main seat. Because the movement is independent, the core assembly can advantageously operate within the solenoid subbase subassembly 26 with a shorter actual core stroke 162 (the total distance the core assembly moves between a high and low position under the influence of the energized coil in the valve operation) to produce a higher overall force per length relative to a conventional core assembly stroke that is longer than a poppet stroke 164. Even though the core assembly could theoretically move a longer distance than that of the poppet, the actual core stroke 162 can be shorter than the poppet stroke 164, because the core assembly does not need to travel the same or a greater distance as the poppet to effectuate the valve operation, in contrast to the customary design in other valves.

The core stroke during the coil enerization is shorter than the poppet stroke which itself is shorter than the movement of the core in the pilot valve in conjunction with the core assembly return spring 24. This core stroke differs from a traditional pilot valve where the core stroke is greater than the poppet stroke.

Thus, the shorter stroke allows the core assembly to operate more efficiently within a region of greater magnetic field strength caused by the solenoid coil, where such region is generally more central to the solenoid assembly and associated coil, given the orientation shown in the figures. Thus, there is a reduction of the valve's overall power input and ultimate consumption. This reduction in power provides a benefit over traditional direct acting pilot valves, which require a solenoid pulling force over a longer stroke because the core assembly stroke is generally longer than the poppet stroke. This pulling force is necessary even when the pulling force decreases significantly, given a constant power input to the solenoid, due to rapidly decreasing magnetic field strength at the lower portions of the stroke. With the present disclosure, the design of the solenoid assembly requires less input power because the shorter stroke relative to the poppet stroke allows the core assembly to operate in a higher magnetic field region during the various modes of the valve operation. This reduced input power is also believed to reduce the size and relative cost of the solenoid assembly.

The solenoid assembly 4 includes a coil 14 wound around a spool 38, radially disposed about the solenoid base subassembly 26. The coil generates a magnetic field when energized. An electrical connector 36 is electrically coupled to the coil 38 to provide power to the coil.

The solenoid base subassembly 26 generally includes a stopper 80, sometimes referred to as a “plug nut.” The stopper 80 is generally the upper portion of the solenoid base subassembly and is retained in a fixed position relative to the solenoid assembly 4 by the nut 34. The solenoid base subassembly further includes a lower portion generally referred to as a bonnet 84. The bonnet 84 and the stopper 80 are spaced apart by a gap 86 in fixed relation by a core tube 82, generally made of non-magnetic stainless steel, that is pressed and/or welded to each component. The gap 86 allows a magnetic field created by an energized solenoid assembly 4 to pull the core assembly 20 upward and toward the stopper 80. A pilot exhaust port 88 is longitudinally formed in the stopper to allow pilot pressure fluids to the valve. Due to manufacturing considerations, the port 88 can be formed longitudinally and a cross-opening 92 drilled or otherwise formed laterally to the exhaust port. The port 88 can be plugged with a plug 90, such as a stainless steel ball, pressed into position. The cross-opening 92 is still fluidically coupled to pilot exhaust port 88 and can provide the outlet for exhaust gases from the pilot valve at certain modes of the operation. The O-ring 30 is sized to expand over the flange 28 and engage the cross-opening 92 to act as a seal. When the exhaust gases are ported through the pilot exhaust port 88, the O-ring 30 can slightly expand from the pressure in the port and allow the pilot fluids to exit the valve.

A pilot exhaust port seat 94 is formed on the lower end of the stopper 80. The seat is effectively a protrusion with the pilot exhaust port 88 extending therethrough, formed adjacent to a recess 96 in the stopper. The recess 96 is sized to be the same or slightly larger than the upper portion of the core assembly 20. Thus, when the coil 14 is energized so that the core assembly is pulled toward the stopper 80 and the pilot exhaust port seat 94, the core assembly 20 can enter the recess 96 and seal against the pilot exhaust port seat 94.

The bonnet 84 includes a spring support shoulder 108 formed in the lower portion of the bonnet between the first opening 72 and the second opening 124. The bonnet 84 is used to house the core assembly 20 in a first opening 72 and a lower larger second opening 124. The first opening 72 slideably engages the core assembly and the second opening 124 supports the core return spring 24. The second opening 124 is also adapted to slideably engage the poppet 40 with the wall seal 50 coupled thereto. The spring support 108 is sized to allow the spring 24 to be supported between the support 108 and the spring seat 22 formed on the core assembly 20. Thus, the core assembly 20 is biased downwardly toward the poppet in a de-energized state.

The core assembly 20 includes a core 78 having an opening 98 longitudinally formed in the core. An upper seal disc 100 is sized to be inserted into the opening 98 and fit up against a shoulder formed in the opening 98. Further, the core assembly includes a disc spring 102 that is coupled to the upper seal disc 100 so that the upper seal disc 100 is biased upwardly toward the shoulder and toward the pilot exhaust port seat 94 on the stopper 80. The core assembly 20 further includes a support 104 that is generally “nail-shaped” in that the support has an extended portion sized to fit within the inner diameter of the disc spring 102 and a flattened flange portion sized to fit over the lower end of the spring. The flange portion can further include a recess toward a central area of the flange portion to receive and center a portion of a lower seal disc 106. The lower seal disc 106 is sized to fit within an opening in the lower end of the core assembly 20 by compressing it through an entry opening and allowing it to expand in the core assembly in a cavity formed above the entry. The disc spring 102 can further bias the support 104 and the lower seal disc 106 toward the lower end of the core assembly 20 and a corresponding seat of the poppet 40 described below.

As described above, the poppet 40 includes a poppet piston 42 and a recess 44. The poppet 42 has a cross-sectional area sized to fit within the opening 124 of the bonnet 84. The wall seal 50 is advantageously a U-cup type of seal, opening toward the bottom and sized to engage the recess 44 on an inner diameter and the opening 124 on the outer diameter of the seal. The U-cup wall seal can sealingly expand when pressure is supplied to the seal from a lower portion to radially expand the inner and outer wall portions of the U-cup seal. However, when pressure is either not supplied to the lower portion of the seal for expansion or pressure occurs above the seal so that the flanges are compressed, the U-cup wall seal is not forced into a sealing condition and can allow easier movement of the poppet.

The poppet 40 includes a poppet seat 110. The poppet 40 further includes a pilot port 112 formed longitudinally through the poppet piston and through the poppet seat 110. The poppet seat 110 is adapted to sealingly engage the corresponding lower seal disc 106 coupled to the core assembly 20. Importantly, the poppet and the core assembly 20 can move independently of each other, that is, in the same or different direction depending upon the particular state of operation. The pilot port 112 is fluidically connected to the inlet port 8 by a connecting port 114 generally formed at an angle to the pilot port 112 and below the wall seal 50.

The poppet is formed with a reduced portion 126, having a reduced cross-sectional area. The reduced portion 126 allows more flow area past the reduced portion and through a main flow opening 116 formed relative to the poppet piston 42 in the valve body between the inlet port 8 and the device port 10.

The main flow opening 116 forms a flow path between the inlet port 8 and the device port 10 and is sized to allow a portion of the poppet 40 to move up and down therein. The main flow opening is axially aligned with tat least the poppet 40 and generally other associated elements.

Below the reduced portion 126 is the seat seal recess area 46 described above. The seat seal recess area generally includes a recess formed between two flange portions 128, 130. The cross-sectional area of the circumferential flange portions 128, 130 is the same or less than the cross-sectional area of the main flow opening 116 formed in the body 6 so that a portion of the poppet pilot can slideably move within the opening 116. Even though the cross-sectional areas of the flange portions 128, 130 are smaller than the opening 116, when the seat seal 54 is seated in the seat seal recess 46, the movement of the poppet 40 is restricted upwardly because the seat seal cross-sectional area is greater than the cross-sectional area of the main flow opening 116.

The seat seal 54, such as an O-ring, is adapted to engage a lower portion of the main flow opening 116. Because the seat seal 54 engages from the bottom upwardly in the position shown in FIG. 3, the seat is herein termed an upper main seat 116. Due to stress on the O-ring from the engagement, the O-ring can be supported on its outer diameter by a seal support 56. The seal support 56 is generally a circular channel having a recess on an inner portion of the support that can be sized to engage an outer portion of the seat seal 54. Below the seat seal 54 and spaced a distance away from the seal is the upper end of the fitting 66. The fitting 66 is sized to fit in a cavity 120 of the body 6. The spaced distance allows a flow between the device port 10 and the outlet port 12 to establish a first flow path 132 when the seat seal 54 is upwardly disposed. The upper end of the outlet fitting 66 is sized and adapted to form a lower main seat 122 to be sealingly engaged by the lower portion of the seat seal 54 at certain modes in the valve operation.

In general, the poppet is biased upwardly by the poppet return spring 60. The spring 60 is supported by a guide ring 64 which itself is supported by a shoulder 136 formed in an opening 134 of the fitting 66. The guide ring 64 is described in more detail below. In general, the guide ring 64 guides the lower portion of the poppet 40 herein termed the poppet guide 48. The guidance helps provide alignment of the poppet as it moves up and down in the body 6. Thus, depending upon the pressures and solenoid activation, the poppet 40 and its related seat seal 54 can move between an upper sealing engagement with the upper main seat 118 and a lower sealing engagement with the lower main seat 122 to establish a poppet stroke for the distance therebetween. The seats 118 and 122 generally have a rounded corner to avoid cutting into the resilient seat seal 54.

The O-ring 58, described above, is adapted to sealingly couple the fitting 66 with the lower portion of the valve body 6. The fitting 66 and/or the bonnet 84 of the solenoid subassembly 26 can be threadably engaged with the body 6 in some embodiments. The outlet fitting 66 can further be coupled with the cap 68 to cooperate with a tube or other conduit coupled to the fitting 66.

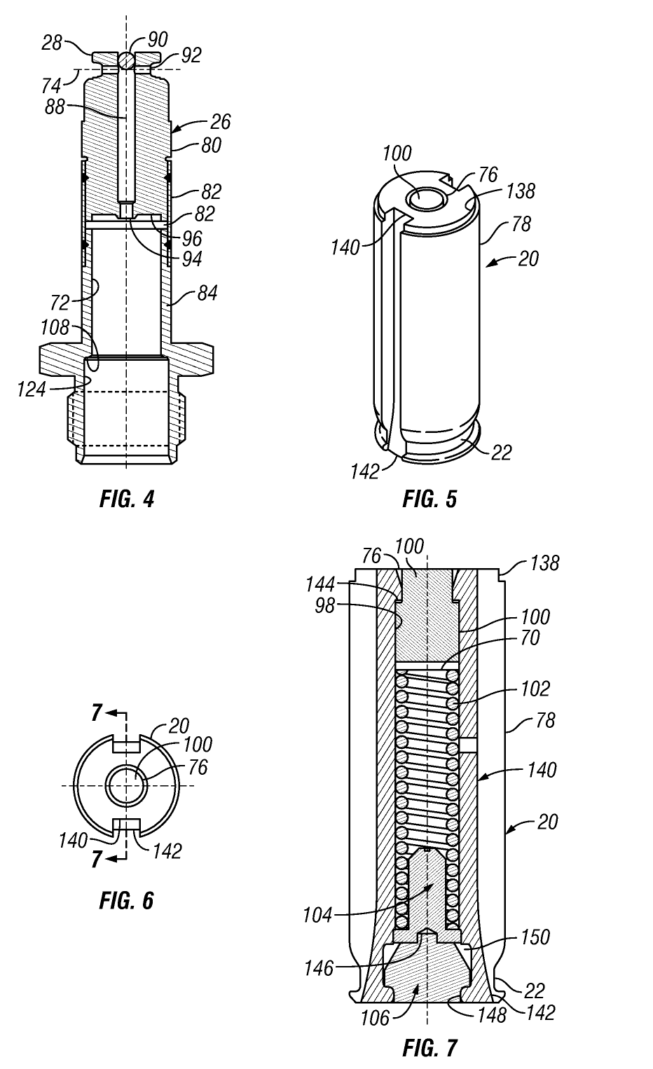

FIG. 4 is a cross-sectional schematic view of the solenoid base subassembly. The solenoid base subassembly 26, as described above, includes the stopper 80, the bonnet 84, with the core tube 82 coupling the prior two components together. A gap 82 separates the stopper 80 and the bonnet 84 as is known to those with ordinary skill in the art to effectuate movement of an armature in a magnetic field created by the coil described above. In this disclosure, the armature includes the core assembly 20. The core assembly 20, described above, is sized to slideably move within the opening 72 formed in the bonnet 84. Similarly, the poppet 40 is sized to slideably move within the opening 124 formed below the opening 72. The spring support 108 is formed by a shoulder at the intersection of the opening 72 and the opening 124. The stopper 80 further includes the pilot exhaust port 88 longitudinally formed therethrough. The exhaust port 88 extends on an upper end to the top of the stopper that is plugged by a plug 90 to the lower end through the seat 94 formed around a recess 96 of the stopper 80. The pilot exhaust port 88 fluidically communicates with a cross-opening 92 formed through the upper portion of the stopper 80. The flange 28 forms a recess 74 sized to receive the O-ring 30 described above. The O-ring 30 provides a seal around the cross-opening 92 during operation, unless exhaust gases in the exhaust port 88 are exhausted by pushing outwardly the O-ring 30 to allow fluids such as gases, to escape thereby.

FIG. 5 is a prospective schematic view of the core assembly. FIG. 6 is a top schematic view of the core assembly of FIG. 5. The figures will be described in conjunction with each other. The core assembly 20 includes a core assembly step 138. The cross-sectional area of the core assembly step 138 is sized to be received within the cross-sectional area of the recess 96 formed in the stopper 80 described above. The top of the core assembly 20 includes an opening 76 sized to allow the upper seal disc 100 to slideably be disposed therethrough. The upper seal disc 100 is allowed to engage the pilot exhaust port seat 94 formed in the stopper 80. The lower end of the core assembly 20 includes a spring seat 22 sized to receive the spring 24 shown in FIG. 3 that biases the core assembly downward. Further, the core assembly 22 includes one or more exhaust openings 140. The exhaust openings 140 provide a channel or other opening for the exhaust gases allowed into the bonnet above the poppet 40 through the pilot port 112 to flow upward past the core assembly 20 and through the pilot exhaust port 88 when the upper seal disc 100 is not engaged with the seat 94, as shown in FIG. 3. In some embodiments, the exhaust opening 140 can include a taper portion 142.

FIG. 7 is a cross-sectional schematic view through FIG. 6 of the core assembly. The core assembly 20 includes a core 78 with various seals and a spring assembled therein. The core assembly is formed with the core assembly step 138 sized to be received within the cross-sectional area of the recess 96 formed in the lower end of the stopper 80. The opening 98 is formed longitudinally through the core assembly 20 to receive the upper seal disc 100, a washer 70, a disc spring 102, a support 104, and a lower seal disc 106, generally in that order. The lower seal disc 106 can engage the support 104 and be centered by a protrusion 146 being inserted into a corresponding hole in the stopper 104. The lower seal disc 106 has generally a larger cross-sectional area than the opening 148 formed in the lower portion of the core assembly 20 but not greater than the cross-sectional area of the cavity 150 formed above the opening 148. Thus, the lower seal disc 106 can be compressed and squeezed through the opening 148 and then allowed to expand in the cavity 150 after passing through the opening 148. The disc spring 102 helps maintain the upper and lower seal discs 100, 106 into extended positions within their respective contact areas of the core assembly. A shoulder 144 formed in the opening 98 restricts the movement of the upper seal disc 100. The exhaust opening 40, as shown in the cross-sectional view, which may have a taper 142 at the lower end of the core assembly 20.

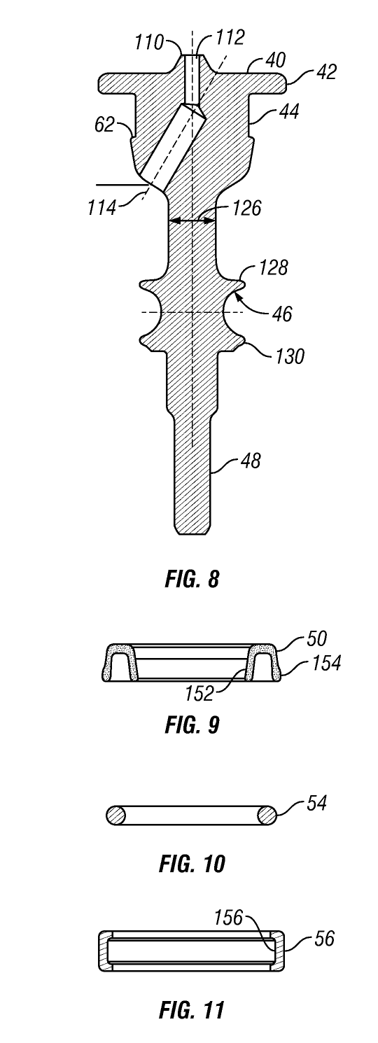

FIG. 8 is a cross-sectional schematic view of the poppet. FIG. 9 is a cross-sectional schematic view of the wall seal. FIGS. 8 and 9 will be described in conjunction with each other. The poppet 40 generally includes the poppet piston 42 formed toward an upper end of the poppet through which a pilot port 112 is formed. The pilot port 112 extends through the upper portion of the poppet and through a seat 110. The seat 110 is adapted to be engaged by the lower portion of the lower seal disc 106 shown in FIG. 7. The pilot port 112 is fluidically connected to a connecting port 114 that in turn is fluidically connected to the inlet port of the valve, shown in FIG. 3. The wall seal recess 44 forms an inward diameter contact area for the wall seal 50 with an inner wall portion 152. An outer wall portion 154 of the wall seal 50 is sized to engage the wall of the opening 124 in the bonnet 84, shown in FIG. 3. The longitudinal movement of the wall seal 50 relative to the poppet 40 is restricted on a top end by the poppet piston 42 and a lower end by a shoulder 62 formed on the poppet. The connecting port 114 is generally formed in the poppet below the volume occupied by the wall seal 50. A reduced portion 126 of the poppet operates in conjunction with the opening 116 formed in the body, shown in FIG. 3, to allow fluid to flow thereby. A first flange portion 128 and a second flange portion 130 extend outward from the reduced portion 126 so that a seat seal recess 46 is formed therebetween. The seat seal recess 46 can receive the seat seal 54, described above. The cross-sectional area of the flanges 128, 130 in combination with the seat seal 54 is generally less than the cross-sectional area of the poppet piston 42 in the upper portion of the poppet. Thus, a differential pressure can be used to move the poppet up or down depending on the mode of the valve operation. The poppet 40 further includes a poppet guide 48 formed on a lower section of the poppet. The poppet guide helps provide a lateral stability and alignment of the poppet as it moves up and down.

FIG. 10 is a cross-sectional schematic view of the seat seal 54 in at least one embodiment. Figure II is a cross-sectional schematic view of the seal support 56. FIGS. 10 and 11 will described in conjunction with each other. The seat seal 54 can be assembled to engage the seat seal recess 46, shown in FIG. 8. The upward and downward stresses on the seat seal might otherwise dislodge it by causing it to stretch past the flanges 128, 130 without additional support. Therefore, it can be advantageous to use a seal support 56. The seal support includes an inner seal support recess 156. The seal support recess 156 generally has a cross-sectional area that is sized to receive the seat seal 54 and prevent substantial outward expansion even with the upward and downward stresses caused by the seat seal seating on the seats 118, 122, as shown in FIG. 3. To assist the seal support 156 to be retained over the seat seal 54, the recess can include one or more steps on the top and bottom of the recess 156. The recess steps are generally sized so that the seat seal 54 has to be compressed for the seal support to be inserted thereover. Thus, when the seat seal 54 uncompresses when it engages the recess 156, the upward and downward movement of the seal support 156 is restrained.

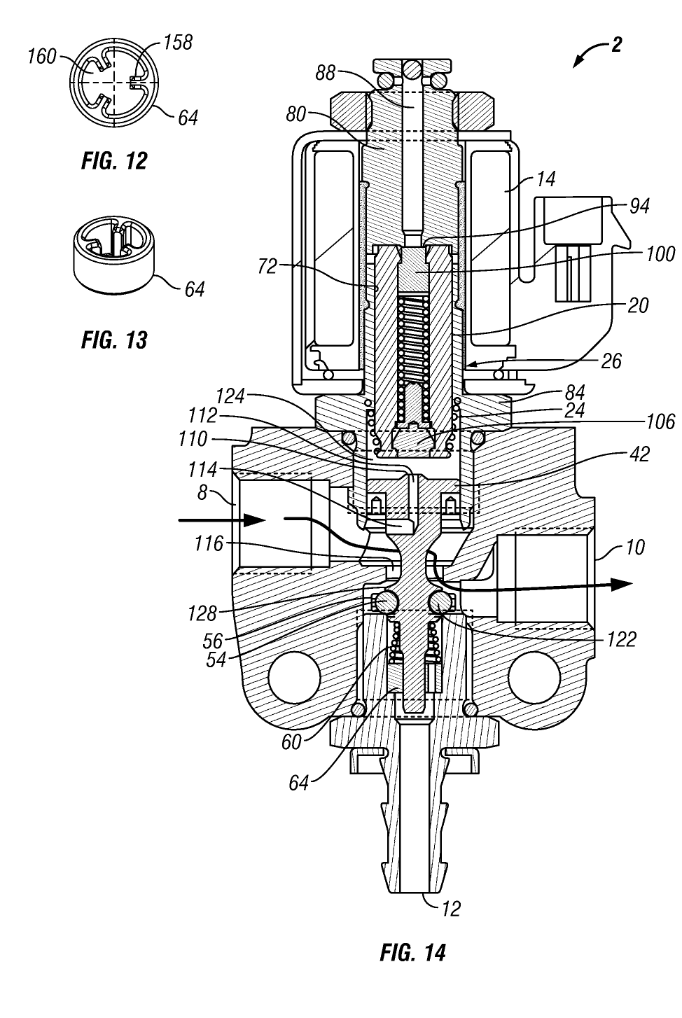

FIG. 12 is a top schematic view of the guide ring. FIG. 13 is a top perspective schematic view of the guide ring. The figures will be described in conjunction with each other. The guide ring 64 is disposed in the lower portion of the valve body 6, specifically in a fitting opening 134 formed in the fitting 66 that is assembled to the lower portion of the valve body 6. The guide ring 64 provides a guiding surface to the poppet guide 48 formed on a lower portion of the poppet 40, shown in FIG. 3. The guide ring 64 further provides a bottom surface for the spring 60 to abut on one end and bias the poppet 40 upwardly. To allow fluid between the devise port 10 and the outlet port 12 to flow through the guide ring 64 and still support the poppet guide 48, one or more flow channels 160 are formed through the guide ring 64. Thus, one or more guide ring ribs 158 can be used to guide the poppet guide 48 of the poppet, shown in FIG. 3, toward a central portion of the guide ring 64 and still allow the fluid to pass thereby. Thus, in viewing FIG. 3, the fluid along the flow path 132 can flow from the device port 10 toward the center of the valve between the seat seal 54 and the lower main seat 122 when the poppet piston 42 and seat seal 54 are disposed upwardly. The flow can continue past the spring 60 in the fitting opening 134, through the flow channels 160, and exit the outlet port 12.

Having described the elements and various functions, the operation of the valve can be described as follows. Referencing FIG. 3, supply pressure from inlet port 8 is present under the poppet 40, while pressure over the poppet is controlled via the moveable core assembly 20. When the solenoid assembly 4 is de-energized, the core assembly 20 that is biased by the core assembly return spring 24 rests on the poppet seat 110 of the poppet 40, effectively blocking supply pressure. The exhaust opening channels 140 and other flow paths allow any residual pressurized fluid, such as gases, in openings 72, 124 of the bonnet 84 to vent to the volume above the core assembly 20 and out the pilot exhaust port 88 and cross opening 92. This pressure differential between the supply pressure and the substantially ambient pressure across the poppet 40 creates an upward force, which holds the poppet in its uppermost position to seal with the seat seal 54 against the upper main seat 118. The valve is now in a de-energized or closed state. The poppet return spring 60 aids the return of the poppet to its uppermost or closed position at low operating pressures when a pressure differential is low and also during loss of pressure during operation.

FIG. 14 is a cross-sectional schematic diagram of the exemplary pilot valve in an energized state. In an energized state, the poppet 40 is in a lowermost position, the core assembly 20 is resting on the pilot exhaust port seat 94, the inlet port 8 is in communication with the device port 10, and the outlet port 12 is shut off from communication with the other two ports. When the solenoid assembly, specifically the coil 14, is energized, the core assembly 20 is pulled upwardly toward the stopper 80 and lifts off the poppet seat 110, overcoming the force of the core assembly return spring 24. The core assembly 20 moves upwardly to sealing engage the pilot exhaust port seat 94 with the upper seal disc 100. The supply pressure from the inlet port 8 pressurizes the openings 72, 124 in the bonnet 84 through the ports 114, 112. At this mode in the valve operation, the pressure differential below and above the poppet 40 is essentially zero and the poppet piston has little to no influence over the position of the poppet in the opening 124. However, the supply pressure in the inlet port 8 pressurizes the main flow opening 116 as well, and creates a downward force on the poppet seat seal 54 across the cross-section area of the seal 54 and the poppet in that zone of the poppet. The downward force overcomes the bias of the poppet return spring 60 and pushes the seal 54 into sealing engagement with the lower main seat 122 to shut off the outlet port 12 and allow communication between the inlet port 8 and the device port 10.

The seal 54 and poppet 40 cross sectional area exerts a downward force on the poppet through the de-energized and energized modes of the valve operation. This force is due to a pressure differential created between the supply pressure through the main flow opening 116 acting on the upper portions of the seat seal 54 and the little to no pressure under the seat seal to the outlet port 12. The poppet 40 moves upward when the pressure is applied to the bottom of the poppet piston 42 and not the top of the poppet piston, for example, when the valve is energized, described above. The poppet moves because the greater cross sectional area of the poppet piston at the supply pressure creates a greater upward force on the valve than the downward force at the same pressure on the smaller cross section area of the seal 54 and corresponding cross section of the poppet.

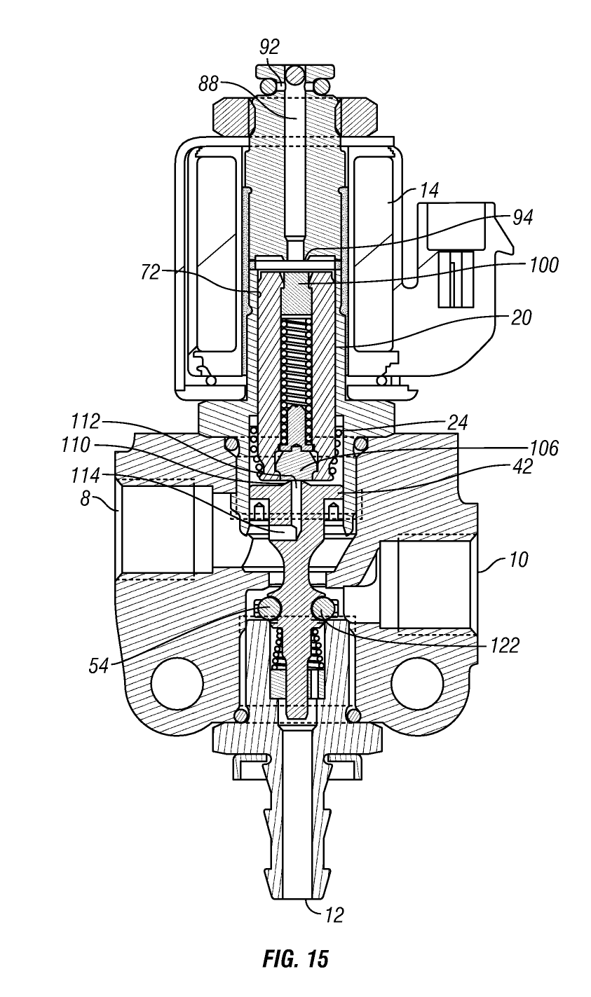

FIG. 15 is a cross-sectional schematic diagram of the exemplary pilot valve in a de-energizing state shown with the core assembly still adjacent the poppet seat. In the de-energizing state, the poppet 40 is in a lowermost position, the core assembly 20 drops down to the poppet piston seat 110, and the poppet 40 returns to an uppermost position in an opposite direction from the prior movement of the core assembly 20.

Upon de-energizing of the solenoid coil 14, the core assembly 20 drops down and overcomes any residual pressure in the openings 72, 124 of the bonnet 84 with the force generated by the coil assembly return spring 24. The core assembly continues to travel past its normal resting position due to the spring 24 to make contact with the poppet piston seat 110 with the pilot port 112 in a lowered position from the prior energized mode. The upper seal disc 100 on the other end of the core assembly correspondingly moves downward away from the pilot exhaust port seat 94 to open the pilot exhaust port 88. The openings 72, 124 are shut off from the inlet port 8 due to the sealing engagement of the lower seal disc 106 over the pilot port 112. The volume of pressurized fluid remaining in the openings 72, 124 is allowed to exhaust through the pilot exhaust port 88. This causes a full pressure differential across the poppet piston 42 which in turn moves the poppet 40 and core assembly 20 resting atop it, in an upwards direction. The poppet 40 and core assembly 20 stop moving once the poppet seat seal 54 sealing engages the upper main seat 118 for a normal resting position.

The invention has been described in the context of preferred and other embodiments and not every embodiment of the invention has been described. Apparent modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intends to protect all such modifications and improvements to the full extent that such falls within the scope or range of equivalent of the following claims.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described herein for clarity in reference to the figures and are not to be limiting of the actual device or system or use of the device or system. The term “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, directly or indirectly with intermediate elements unless otherwise stated, one or more pieces of members together and can further include without limitation integrally forming one functional member with another in a unity fashion. The coupling can occur in any direction, including rotationally. Unless the context requires otherwise, the word “comprise” or variations such as “comprises” or “comprising”, should be understood to imply the inclusion of at least the stated element or step or group of elements or steps or equivalents thereof, and not the exclusion of a greater numerical quantity or any other element or step or group of elements or steps or equivalents thereof. The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

Further, any references mentioned in the application for this patent as well as all references listed in the information disclosure originally filed with the application are hereby incorporated by reference in their entirety to the extent such may be deemed essential to support the enabling of the invention. However, to the extent statements might be considered inconsistent with the patenting of the invention, such statements are expressly not meant to be considered as made by the Applicant(s).

1. A pilot valve, comprising:
a body having an inlet port, a device port, and an outlet port formed in the body to establish one or more flow paths, the body further having a main flow opening having a first seat distal from the inlet port;
a solenoid base subassembly coupled to the body comprising:
a stopper having:
a pilot exhaust port formed longitudinally through the stopper; and
a bonnet having:
a first opening formed longitudinally in the bonnet and aligned with the pilot exhaust port adjacent the pilot exhaust port seat; and
a second opening aligned with the first opening, the second opening being formed in the bonnet and distal from the pilot exhaust port of the stopper; and
a core tube adapted to couple the stopper and the bonnet with a gap formed between the stopper and bonnet;
a core assembly slidably coupled to the solenoid base subassembly in the first and second openings, comprising:
a core having a core opening formed longitudinally through the core and axially aligned with the body main flow opening;
a first seal disc slidably disposed in the core opening toward the pilot exhaust port for sealing engagement with the exhaust port;
a second seal disc slidably disposed in the core opening toward the body main flow opening and distal from the pilot exhaust port; and
a spring disposed in the core opening between the first seal disc and the second seal disc;
a solenoid assembly disposed around at least a portion of the solenoid base subassembly, the solenoid assembly having a toroidal coil adapted to be energized to create a magnetic field longitudinally through the solenoid base subassembly;
a poppet slidably disposed in the second opening of the bonnet and the main flow opening of the body, the poppet being aligned with the main flow opening and the poppet having:
a poppet piston slidably disposed in the second opening of the bonnet, the poppet piston having a port in communication between the inlet port and the core assembly, the port being aligned with the second seal disc of the core assembly for sealing engagement with the second seal disc; and
a seat seal coupled to the poppet distal from the second opening and adapted to sealably engage the first seat on the main flow opening distal from the poppet piston relative to the main flow opening; and
a second seat coupled to the body distal from the poppet piston and adapted to be engaged by the seat seal distal from the first seat, the poppet defining a stroke between the first seat and the second seat.

2. The valve of claim 1, further comprising a recess formed around the pilot exhaust port in the stopper to receive the core assembly when the valve is energized.

3. The valve of claim 1, wherein the poppet comprises a poppet guide disposed distal from the poppet piston and the valve further comprises a guide ring wherein the poppet guide is adapted to be slidably engaged with the guide ring to guide the poppet along the poppet stroke.

4. The valve of claim 1, wherein the pilot exhaust port communicates with a cross opening to allow pilot exhaust to escape from the pilot exhaust port through the cross opening and a seal is flexibly disposed around the cross opening.

5. The valve of claim 1, wherein the core assembly is biased toward the poppet.

6. The valve of claim 1, wherein the poppet assembly is biased toward the core assembly.

7. The valve of claim 1, further comprising a wall seal coupled to the poppet and slidably disposed in the second opening of the bonnet.

8. The valve of claim 1, further comprising a seal support radially disposed around the seat seal.

9. The valve of claim 1, further comprising an outlet fitting coupled to the body distal from the solenoid base subassembly, the outlet fitting establishing the second seat for engagement by the seat seal.

10. The valve of claim 1, wherein the core assembly can move independently in the same or different direction as the poppet to operate the valve between an energized state and a de-energized state.

11. The valve of claim 1, wherein the core assembly has a core stroke and the poppet has a poppet stroke and the core stroke is shorter than the poppet stroke.

12. A pilot valve, comprising:
a body having an inlet port, a device port, and an outlet port formed in the body to establish one or more flow paths;
a solenoid base subassembly;
a solenoid assembly disposed around at least a portion of the solenoid base subassembly, the solenoid assembly having a toroidal coil adapted to be energized to create a magnetic field longitudinally through the solenoid base subassembly;
a core assembly slidably coupled to the solenoid base subassembly, the core assembly having a core stroke;
a poppet slidably disposed in the valve body, the poppet having a poppet stroke;
wherein the core assembly can move independently in the same or different direction as the poppet to operate the valve between an energized state and a de-energized state.

13. The valve of claim 12, wherein the core stroke is shorter than the poppet stroke.

14. The valve of claim 13, wherein the core assembly has a higher average pulling force per length of core assembly movement compared to a core assembly that can only move in the same direction as the poppet and has a longer core stroke than the poppet stroke.

15. A pilot valve, comprising:
a body having an inlet port, a device port, and an outlet port formed in the body to establish one or more flow paths, the body further having a main flow opening having a first seat distal from the inlet port;
a solenoid base subassembly coupled to the body comprising:
a stopper having a pilot exhaust port formed longitudinally through the stopper;
a bonnet coupled to the stopper having a first opening formed longitudinally in the bonnet and aligned with the pilot exhaust port; and
a core assembly slidably coupled to the solenoid base subassembly in at least the first opening, the core assembly having a first end and a second end and a sealing surface disposed on each end;
a solenoid assembly disposed around at least a portion of the solenoid base subassembly, the solenoid assembly having a coil adapted to be energized to create a magnetic field longitudinally through the solenoid base subassembly;
a poppet slidably disposed in the second opening of the bonnet and the main flow opening of the body and aligned with the main flow opening, the poppet having:
a poppet piston slidably disposed at least partially in the bonnet, the poppet piston having a pilot port in communication between the inlet port and the core assembly, the port being aligned with a least one of the sealing surfaces of the core assembly for sealing engagement; and
a seat seal coupled to the poppet distal from the bonnet and adapted to sealably engage the first seat of the main flow opening distal from the poppet piston; and
a second seat coupled to the body distal from the poppet piston and the first seat and adapted to be engaged by the seat seal distal from the first seat, the poppet having a stroke between the first seat and the second seat.

16. The valve of claim 15, further comprising a pilot exhaust port seat formed in one end of the stopper around the pilot exhaust port.

17. The valve of claim 15, further comprising a second opening formed in the bonnet and aligned with the first opening, the second opening being formed in the bonnet distal from the pilot exhaust port of the stopper and wherein at least a portion of the poppet piston is disposed in the second opening.

18. The valve of claim 15, wherein the solenoid base subassembly further comprises a core tube adapted to couple the stopper and the bonnet.

19. The valve of claim 15, wherein the core assembly comprises a core opening formed longitudinally through the core, further comprising:
a first seal disc slidably disposed in the core opening toward the pilot exhaust port;
a second seal disc slidably disposed in the core opening toward the body main flow opening and distal from the pilot exhaust port; and
a spring disposed in the core opening between the first seal disc and the second seal disc.

20. The valve of claim 15, wherein the poppet comprises a poppet guide disposed distal from the poppet piston and the valve further comprises a guide ring wherein the poppet guide is adapted to be slidably engaged with the guide ring to guide the poppet along the poppet stroke.

21. The valve of claim 15, wherein pilot exhaust port communicates with a cross opening to allow pilot exhaust to escape from the exhaust pilot port through the cross opening and a seal is flexibly disposed around the cross opening.

22. The valve of claim 15, wherein the core assembly is biased toward the poppet.

23. The valve of claim 15, wherein the poppet assembly is biased toward the core assembly.

24. The valve of claim 15, further comprising a wall seal coupled to the poppet and slidably disposed in the bonnet.

25. The valve of claim 15, further comprising a seal support radially disposed around the seat seal.

26. The valve of claim 15, further comprising an outlet fitting coupled to the body distal from the solenoid base subassembly, the outlet fitting establishing the second seat for engagement by the seat seal.

27. A method of operating the valve of claim 10, comprising:
energizing the coil to provide a force on the core assembly directed toward the stopper and away from the poppet;
moving the core assembly away from the poppet piston having the pilot port to allow pressurized fluid to enter the opening in the bonnet on a portion of the poppet piston disposed in the opening to counteract pressure on the poppet piston on a distal portion of the poppet piston;
applying the pressurized fluid to the seat seal and forcing the poppet piston away from the first seat of the main flow opening toward the second seat and away from the core assembly to open a flow path between the inlet port and the device port.

28. The method of claim 27, wherein moving the core assembly away from the pilot port overcomes a bias in an opposite direction of a core assembly return spring.

29. The method of claim 27, further comprising moving the core assembly into a sealing engagement with the pilot exhaust port.

30. The method of claim 27, further comprising:
de-energizing the coil;
allowing the core assembly to move toward the poppet piston and engage the poppet port;
exhausting pressurized fluid from the opening in the bonnet;
moving the poppet piston away from the second seat and toward the first seat and the poppet piston to open a flow path between the device port and the outlet port.

31. A method of operating a pilot valve having an inlet port, a device port, and a outlet port defining at least two flow paths, comprising:
pressurizing an inlet port of a de-energized valve;
energizing a coil of a solenoid assembly coupled to a portion of the valve and surrounding a movable core assembly of the valve to pull the core assembly toward a stationary stopper having a pilot exhaust port distal from the inlet port;
sealing the pilot exhaust port with a seal coupled to the core assembly;
flowing pressurized fluid from the inlet port through a pilot port in a piston of a slidable poppet to create a first force on a portion of the poppet piston distal from the inlet port; and
forcing with the first force the poppet piston, axially aligned with the poppet, toward a main flow opening in the valve and away from the core assembly, to move a biased seat seal axially coupled with the poppet from a first main seat to a second main seat to open a flow path between the inlet port and the device port.
